(19) United States
(12) Patent Application Publication
(10) Pub. No.: US 2020/0247624 A1
(43) Pub. Date: Aug. 6, 2020

(54) TRAILER CONVEYOR SYSTEM AND METHOD

(71) Applicant: Duane Adels, Aumsville, OR (US)

(72) Inventor: Duane Adels, Aumsville, OR (US)

(21) Appl. No.: 16/268,035

(22) Filed: Feb. 5, 2019

(51) Int. Cl. B65G 67/20; B60P 1/36

(52) U.S. Cl. CPC B65G 67/20; B60P 3/12; B65G 2201/0294; B60P 1/365

(57) ABSTRACT

Trailer trolley-type conveyor system, comprising a plurality of the elongated rails adapted for installation on a trailer bed, a conveyor system frame adapted for transport back and forth along the rails within a trailer's exterior framework, a plurality of wheels mounted on the frame and adapted for rolling carriage of the frame on the rails, at least one winch adapted for mounting onto the trailer and adapted for pulling the frame with any cargo thereon back and forth along the rails; and at least one lock engaged with one of the frame, the wheels, and the rails, adapted for preventing movement of the conveyor system frame during transport of the trailer.

### FIELD

The present disclosure relates to improvements to trailers, such as trailer systems for hauling wrecked automobiles and semi-trailer systems, wherein access to frontal portions of the trailer are difficult to load because of exterior trailer constraints, and more particularly to a rolling trolley-type conveyor system and method of enabling easy access for loading frontal portions of trailers.

### BACKGROUND

Prior-art automobile trailer systems for transporting wrecked automobiles have been available which have allowed users to place vehicles on the trailer using traditional forklifts. However, because of exterior trailer constraints, such as structural framing for such trailers, access by a forklift to frontal portions of at least a lower deck of the trailer has been limited, especially with moderately-sized forks suitable for longitudinal undergirding of the vehicle chassis. Therefore, there have been required, with past trailer models and methods, specialized forklifts having very long forks suitable for longitudinal undergirding of vehicle chassis. Such forks are capable of placing the vehicle via a rear access point of the trailer, installing it longitudinally along the length of the trailer, and placing it at the front of the trailer lower deck.

Such loading of wrecked automobiles onto frontal portions of lower decks of trailers has been problematic and time-consuming, taking on the order of an extra hour or more per day for one driver, because of the time necessary to place, and/or drag, the car into such a location. And accordingly, such prior loading processes have caused damage to trailers. Loading cars to such a location has also required extra skill in driving such a forklift with longer forks to attempt to insert the wrecked vehicle into the relatively smaller forward lower-deck compartment space on the trailer, all while maneuvering it safely to that location, without hitting the inner sides or top of the trailer. Further, not every auto auction, or wrecked vehicle yard, has had such specially-adapted forklifts.

In those cases of insurance and auction yards, or auto wrecking yards, not having such specially adapted forklifts, prior art trailers have either relied upon an ability to roll wrecked vehicles into the lower frontal position, or positions, of such trailers, or have relied upon dragging the wrecked vehicles into such lower frontal positions. Such dragging has been attempted, for example, when a wrecked vehicle has been immobilized because the wheels have been damaged, or for example when a wrecked vehicle has been immobilized because the electronic parking brake on the wrecked vehicle has been in a locked position. Of course, oftentimes wrecked vehicles' wheels have been damaged, preventing them from rolling freely, and in those cases where vehicles have been dragged, this has often further damaged the wrecked vehicles (for example their transmissions which would otherwise be valuable) or the decking of such trailers.

And while hauling trailers may have been adapted with solid lower decking floors to assist with such dragging operations without excess damage to the trailer floor, such adaptations have been expensive in terms of material costs, wasted fuel associated with heavier trailers, and extra time needed to drag the wrecked vehicles into place. Absent such a solid deck, which has been more expensive to haul, absent a car without functioning wheels, or absent a releasable electronic safety brake, the only option for installing a wrecked vehicle in a forward portion of a lower deck of a trailer, has been with the aforementioned specialized fork lift with especially long forks.

Furthermore, dragging such vehicles into place has not been without its problems. Even when one has been required to drag a vehicle on its non-functioning wheels across a trailer, dragging the vehicle has led to the vehicle skidding around off line, thus making getting the vehicle into place on the trailer more difficult. Therefore, in the case where there have been no effectively rolling wheels, or where the electronic brake has been irremovably engaged, this situation has often resulted in the hauler being unable to put a car on the lowest and forwardmost portion of the trailer, thus wasting fuel and time transporting only a partially-loaded trailer.

As pertaining to loading of semi-trailers, past loading systems have required special, smaller hand-operated pallet jacks and the like, and smaller forklifts, for such loading purposes, but when such specialized equipment has not been available, users have been left to attempt loading in such situations manually using hand trucks or pallet jacks.

Therefore there has been needed an improved system and method for loading wrecked automobiles and other heavy stock into previously difficult to access portions of hauling trailers.

### SUMMARY OF THE INVENTION

In accordance with an aspect and embodiment of the disclosure, there is provided a trolley-type conveyor system adapted for use in a trailer that allows for loading from the rear of the trailer and repositioning the load to the front of the trailer, comprising: a plurality of rails welded or installed in the trailer, a trolley or sled frame carried on a plurality of roller wheels mounted on the frame and adapted for rolling carriage of the frame with the wrecked automobile thereon, or other load, back and forth along the rails with the trailer's exterior framework. One embodiment utilizes solid steel wheel plates to support the weight of the load and securing rings to allow tie-down of the load to the conveyor system frame in preparation for transport. Further, there is provided at least one winch adapted for mounting onto the trailer and adapted for pulling the conveyor system frame with any cargo thereon back and forth along the rails. Further, the conveyor system is provided with at least one lock engaged with one of the frame, the wheels, and the rails, adapted for preventing movement of the conveyor system frame during loading and transport of the trailer.

Thus, the conveyor system frame is adapted to be lockable in the fore and aft positions in order to provide safe and secure loading and transport. In an embodiment, the locking mechanism is comprised of a sturdy female-type receptacle, or receiver, that is firmly attached or welded to the trailer, a sturdy locking male-type member that is firmly attached or welded to the conveyor system frame, and a locking pin that may be inserted in holes in the receptacle and member when the conveyor system frame is in the proper position with the male member inserted into the female member. There is a receptacle at each corner of the trailer, thus preferably four receptacles or receivers (two mounted forwardly on the trailer and two mounted aft on the trailer) and a corresponding locking member at each corner of the conveyor system frame (two mounted forwardly on the frame and two mounted aft on the frame). Preferably, at least one of the corresponding locking members comprises a forward hitch receiver (female member) adapted for mounting on a forward location on the trailer and adapted for receiving and retaining a corresponding forward-facing hitch (male member) mounted on the conveyor system frame for locking the frame in a forward position on the trailer, and a rearward hitch receiver (female member) adapted for mounting on a rearward location on the trailer and adapted for receiving and retaining a corresponding rearward-facing hitch mounted on the frame for locking the frame in a rearward position on the trailer. Thus, the locks are adapted for receiving, retaining, and locking the frame in a forward position, and alternatively for receiving, retaining and locking the frame in a rearward position, on the trailer.

In another embodiment of the disclosure, there may be placed along the rails additional locking points (e.g., racks, or frame members, with a pin) and also additional locking points (e.g., racks, or frame members, with a pin) attached to the conveyor system frame. This would allow locking the frame in intermediate positions along the rails to facilitate transport of loads of varying shape or weight.

Preferably, the conveyor system is conveyed along the rails between the fore and aft positions by means of a double-winch (or dual-winch) system, comprising: first and second winches mounted on a framework at the front or forward portion of the trailer and attached preferably to a forward-facing portion of the conveyor system frame using ropes or cables. The winch ropes or cables are routed and attached to the conveyor system frame at appropriate locations to facilitate movement of the conveyor system frame from the rear to the front of the trailer, or from the front to the rear of the trailer.

Thus, in a preferred embodiment, the winches are stacked one on top of another mounted in the framework at the front end of the trailer. The rope, or cable, from the bottom winch extends from the winch spool past the guides to a first guide pulley mounted midway underneath the trailer and then rearwardly to a pair of re-routing pulleys mounted adjacent an opening in the trailer floor.

The opening in the trailer floor, or bed, allows passage of the lower winch rope through the floor of the trailer, and the opening is positioned approximately three-fourths of the way back from the front of the trailer. One of the re-routing pulleys is mounted on the trailer positioned underneath the trailer adjacent the opening, and a second of the re-routing pulleys is mounted adjacent the opening and on the trailer so as to be at least partially above the level of the floor of the trailer to allow passage of the lower winch rope guided through the pulleys to pass through the opening and re-routed to the upper side of the trailer to extend between the trailer floor and an underside of the trolley frame, the lower winch rope thus being re-routed towards the front of the trailer where an end of the lower winch rope is attached to an eye-let loop, or hook, on the front of the conveyor frame. In this way, spooling in of the lower winch rope serves to move the conveyor frame rearwardly along the rails of towards the rear of the trailer.

The rope or cable from the upper winch extends from the upper winch spool extending along the floor of the trailer preferably to the same eyehook on the front of the frame as the lower winch rope is attached to. In this way, spooling in of the upper winch rope serves to pull the frame along its rollers and rail system to a forward position of the trailer. When the frame is being pulled forward (i.e., the upper winch rope is spooling in), the lower winch is in an unlocked, free spinning, position so that the lower winch rope is free to unspool and extend to allow the frame to be pulled fully forward. When the conveyor system frame is being pulled aft (i.e., the lower winch rope is spooling in), the upper winch is in an unlocked, free spinning, position so that the upper winch rope is free to unspool and extend to allow the conveyor system frame to be pulled fully rearward.

In accordance with another aspect of the disclosure, there is provided a trailer conveyor system and transport trailer combination, comprising: a wheeled trailer having an exterior framework, forward and after portions, and adapted for hauling stock on a trailer bed, a plurality of elongated rails mounted on the trailer bed within the exterior framework of the trailer, and a conveyor system frame adapted for transporting stock within the exterior framework of said trailer. The frame has a plurality of wheels mounted on the underside thereof adapted for rolling carriage of the conveyor system frame on the rails. There is also provided at least one winch adapted for mounting onto the trailer and adapted for pulling the frame with any cargo thereon back and forth along the rails. Further, there is provided at least one lock engaged with one of said frame, the wheels, and the rails, adapted for preventing movement of the frame on the trailer bed during transport of the trailer.

It will be appreciated that, as with a previously-described aspect of the disclosure, there may be provided a mating locking system comprising a plurality of corresponding locking receptacles and posts (or hitches) located on one or more corners of the trailer and/or the frame, and a dual-winch system as previously described for moving the conveyor system frame forward and aft on trailer.

In an automobile hauling-type trailer and conveyor system combination, a lowermost level bed also preferably comprises lateral side edges and at least forward external frame members. In this embodiment, the rails are preferably fixed adjacent each lateral side edge of the trailer, and the conveyor frame comprises forward facing and rearward facing frame portions. Further, preferably with this embodiment of the system, there are provided a plurality of pulleys mounted on the trailer, at least one of the plurality of pulleys being fixed underneath the bed of the trailer, another one of the plurality of pulleys being mounted at least partially above the bed of the trailer.

Preferably, as with previous embodiments, such a conveyor and trailer combination comprises a dual-winch system. The dual-winch system is preferably mounted on the fore frame member of the trailer, with a first winch of the dual-winch system being mounted above a second winch, the first winch having a cable attached to the forward facing portion of the frame for pulling the frame forward along the trailer on the rails, and the second winch having a cable adapted for being routed with the pulleys from underneath the bed to above the bed and attached to the forward facing portion of the frame. In this manner, the second winch is adapted for pulling the frame rearward along the trailer on the rails.

In another aspect and embodiment of the disclosure, the conveyor system frame of each of the previously-described aspects and embodiments may comprise a rectangular framework further comprised of cross members, a plurality of plate wheel bays, and at least one welding ring adapted for receiving and tying vehicle wheels onto the frame and the trailer. Further, in an embodiment of the disclosure, the frame further comprises longitudinally extending internal frame cross members of wider width corresponding with the width of forks on forklifts adapted for allowing scraping of front portions of the forks along the frame without catching on or damaging the frame.

The conveyor system frame moves along the rails by means of solid steel shaped to permit travel only along the rails. In another embodiment, the wheels and rails are replaced by other mechanisms for smooth transport of heavy weights, such as bearings and tracks, without limitation as long as the weight bearing function and stability is preserved.

In any of the foregoing aspects and embodiments of this disclosure, the conveyor system at least one lock may preferably comprise a forward hitch receiver adapted to be mounted on a forward portion on the trailer and adapted for receiving and retaining a corresponding forward-facing hitch mounted on the frame for locking the frame in a forward position on the trailer, and a rearward hitch receiver adapted to be mounted on a rearward portion on the trailer and adapted for receiving and retaining a corresponding rearward-facing hitch mounted on the frame for locking the frame in a rearward position on the trailer.

Further, in any of the foregoing aspects or embodiments of the disclosure, the conveyor system frame comprises at least a forward facing frame portion, and there are further comprised a plurality of pulleys mounted on, or adapted to be mounted on, the trailer, at least one of the plurality of pulleys being fixed underneath the bed of the trailer, another one of the plurality of pulleys being mounted at least partially above the bed of the trailer. Thus, preferably, the dual-winch system of such an embodiment is mounted on the forward frame member of the trailer, with a first winch of the dual-winch system being mounted above a second winch, the first winch having a cable attached to the forward facing portion of the conveyor frame for pulling the frame forward along the trailer on the rails, the second winch having a cable adapted for being routed with the pulleys from underneath the bed to above the bed and attached to the forward facing portion of the frame, the second winch thus being adapted for pulling the frame rearward along the trailer on the rails.

A conveyor system in accordance with these aspects and embodiments of the disclosure addresses the shortcomings of prior art systems, wherein extra-long forks are needed to install a car on a frontal lower-deck portion of an automobile trailer. In this way the trailer is protected against dragging of vehicles along the bed of the trailer, and thus movement of such vehicles in to the frontal lower-deck portion of the trailer is greatly facilitated. This, in turn, save the operator significant amounts of time associated with prior art systems of installing vehicles on trailers. Thus, the apparatus of the present disclosure not only saves time and money, but it also prevents damage to trailers and makes for safer operation and hauling of loads.

It will be appreciated by those skilled in the art that there are various possible combinations of the above-described elements and sub-elements for various embodiments of the disclosure, whether such elements and sub-elements be combined in whole or in part, which may be employed without departing from the scope and spirit of the disclosure as claimed.

The subject matter of the present disclosure is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIG. 1 is a side perspective view of a fifth-wheel-type car trailer in which an embodiment of a trolley-type conveyor system in accordance with one or more aspects of the disclosure could be implemented for hauling wrecked automobiles from one location to another;

FIG. 2 is a partial rear perspective view of a conveyor system with locking mechanisms in accordance with one or more aspects of the disclosure, for use with a fifth-wheel-type car trailer, shown locked in a rearward position ready to receive a load from a forklift;

FIG. 3 is a partial rear perspective view close-up of a rear locking mechanism of the conveyor system of FIG. 2, in accordance with one or more aspects of the disclosure, and shown in a rearward unlocked position;

FIG. 4 is a partial rear perspective view close-up of a portion of a rear locking mechanism of a conveyor system in accordance with one or more aspects of the disclosure, and shown in a midway position, but near the rear, along the rails on a trailer bed;

FIG. 5 is a partial front perspective view of a conveyor system in accordance with one or more aspects of the disclosure shown in a rearward position ready to receive a load from a forklift;

FIG. 6 is a side perspective closeup view of a forward locking system for a conveyor system in accordance with an aspect of the disclosure;

FIG. 7 is a rear perspective view of a double-winch system for a conveyor system in accordance with an aspect of the disclosure;

FIG. 8A is a schematic illustration of the double-winch cable configuration for a conveyor system in accordance with an aspect of the disclosure and shown with the conveyor system in a forward position ready for transport;

FIG. 8B is a schematic illustration of the double-winch cable configuration for a conveyor system in accordance with an aspect of the disclosure and shown with the conveyor system in a rearward position ready to receive a load from a forklift;

FIG. 9 is a plan view illustration of the frame, or bed, for a conveyor system in accordance with one or more aspects of the disclosure.

FIG. 10 is a side perspective view of the installation of lateral locking points to allow more options in securing the position of the conveyor system frame during transport.

### DETAILED DESCRIPTION

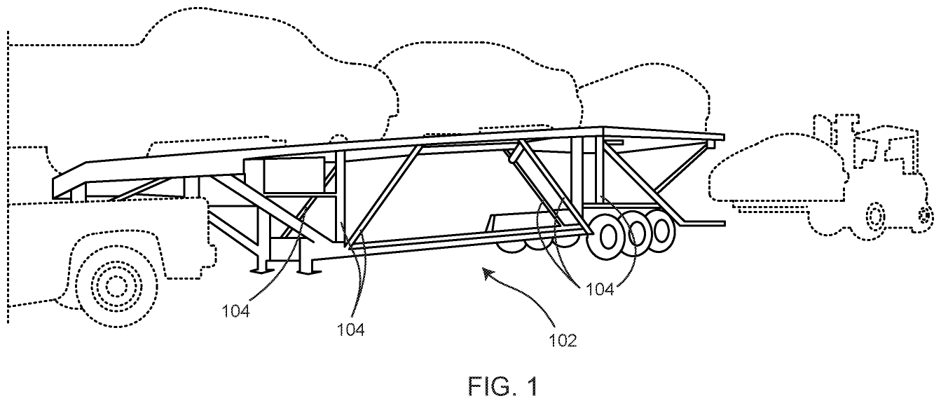

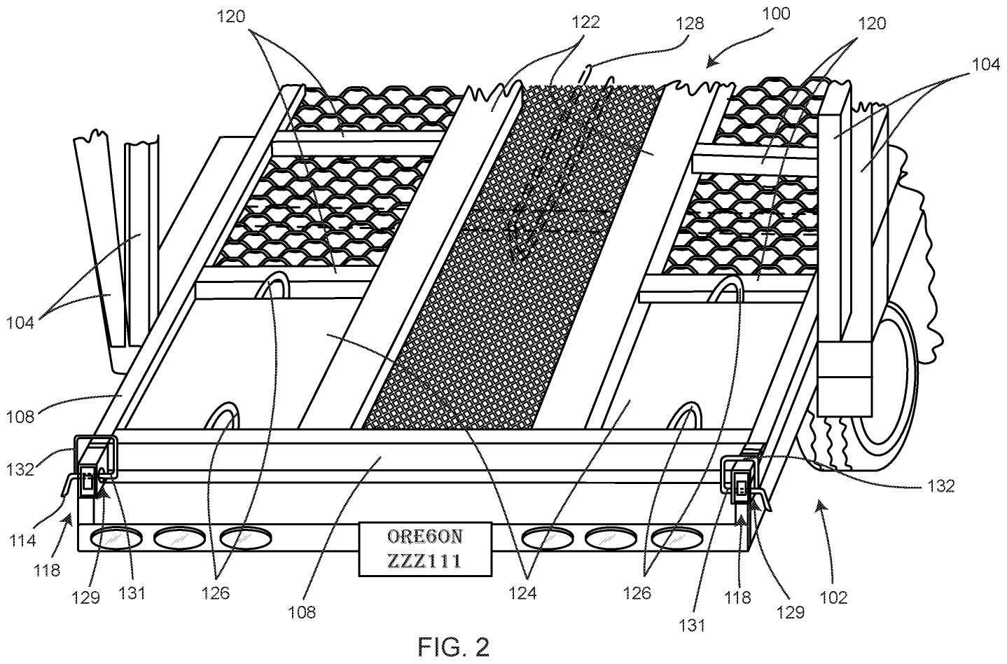

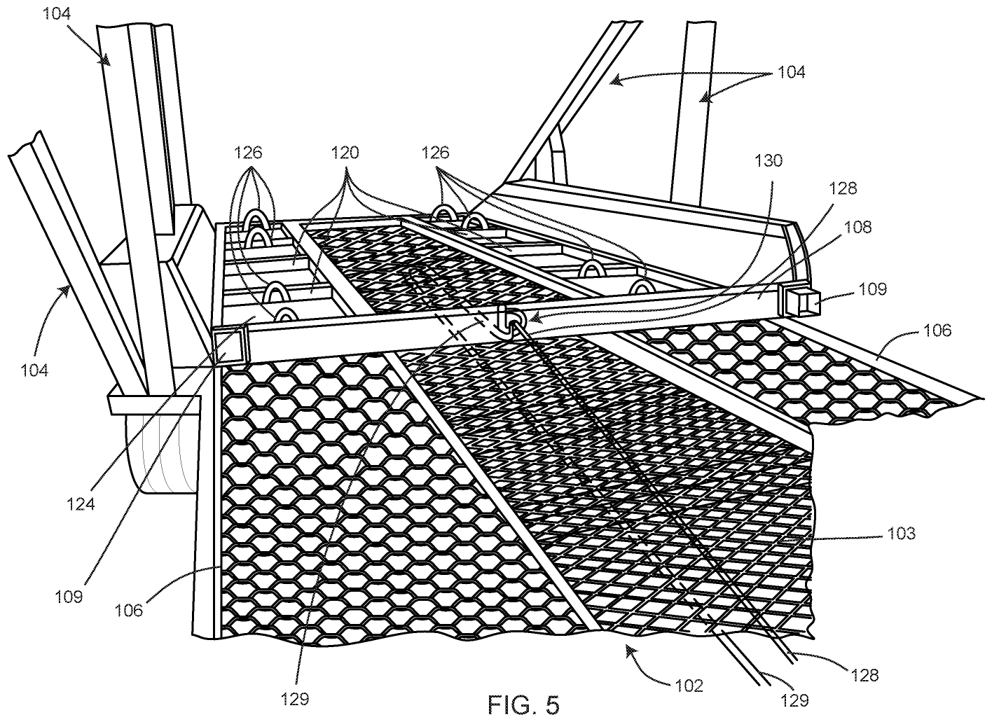

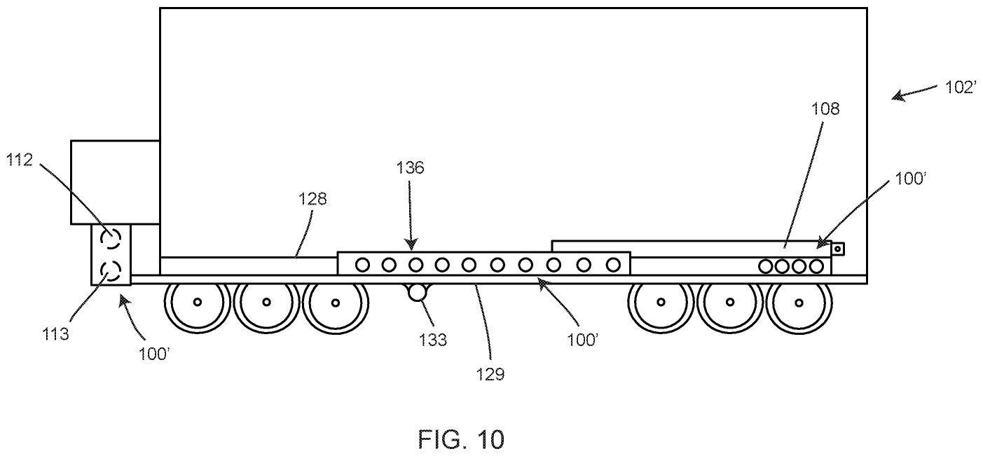

Referring to FIGS. 2-9, in accordance with one or more aspects of the disclosure, there is provided a trolley-type conveyor system 100 adapted for use on a fifth-wheel-type car trailer 102 (FIG. 1), or other form of transport for heavy loads—such as a semi-trailer 102′ (FIG. 10), together with certain adaptations to the conveyor system 100, 100′ as described further below, that is convenient for loading from the rear of the trailer. Such a conveyor system 100 allows easy re-positioning of the load to the front of the trailer 102, and comprises: a conveyor system frame 108, the frame having lateral cross members 120 and longitudinal cross members 122. The conveyor system frame 108 further comprises plate wheel bays 124 with convenient securing rings 126 on two sides of each plate wheel bay, and conveyor frame lock systems 118.

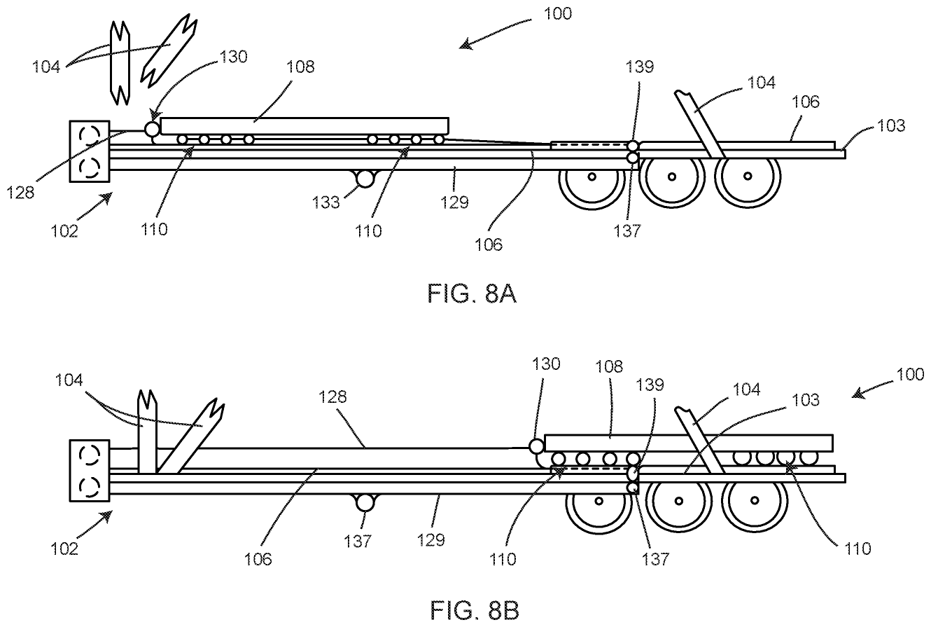

Referring specifically to FIGS. 1, 8A, and 8B, it is noted that the existence of trailer side braces 104 in the particular configuration shown precludes the loading of the front section of the trailer 102 from the side. Side loading may be difficult or impossible with other types of trailers, including semi-trailers that may have solid sides.

There may be additional reasons that side loading of a trailer 102 is difficult or not practical, such as the physical configuration of the loading area, so that the disclosure may be useful even if the trailer side braces 104 are not present.

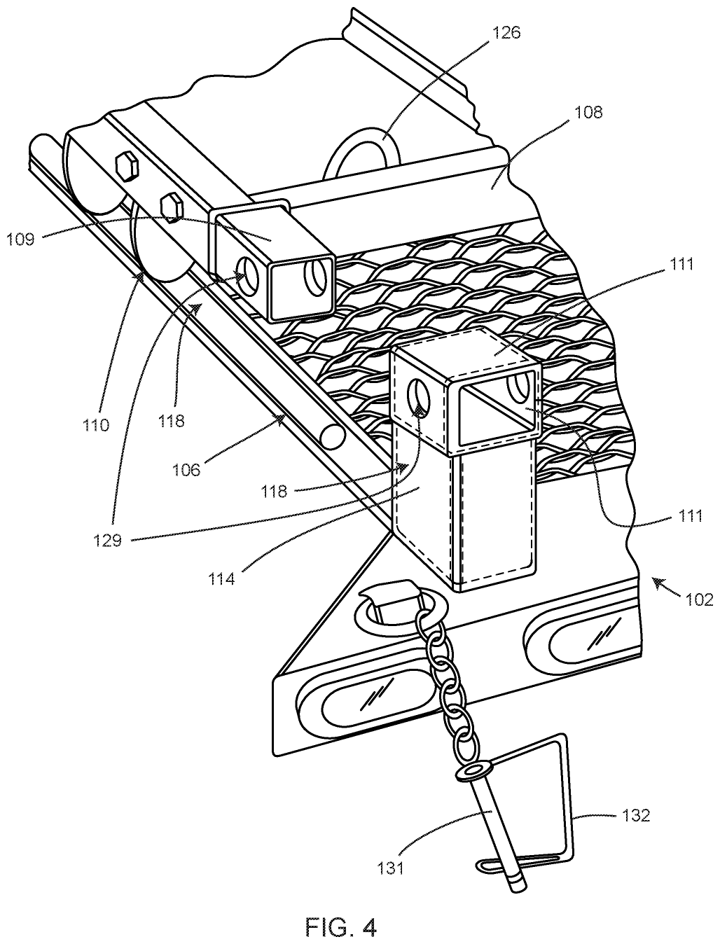

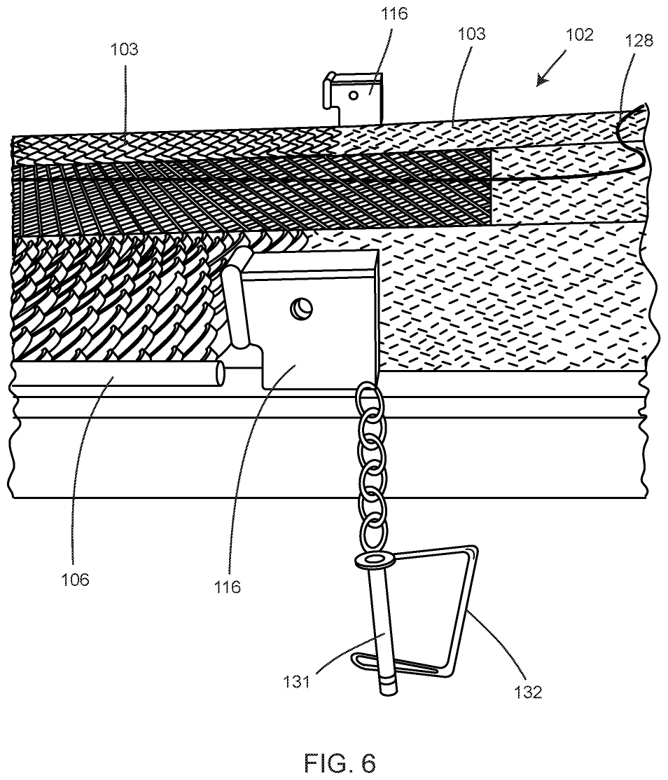

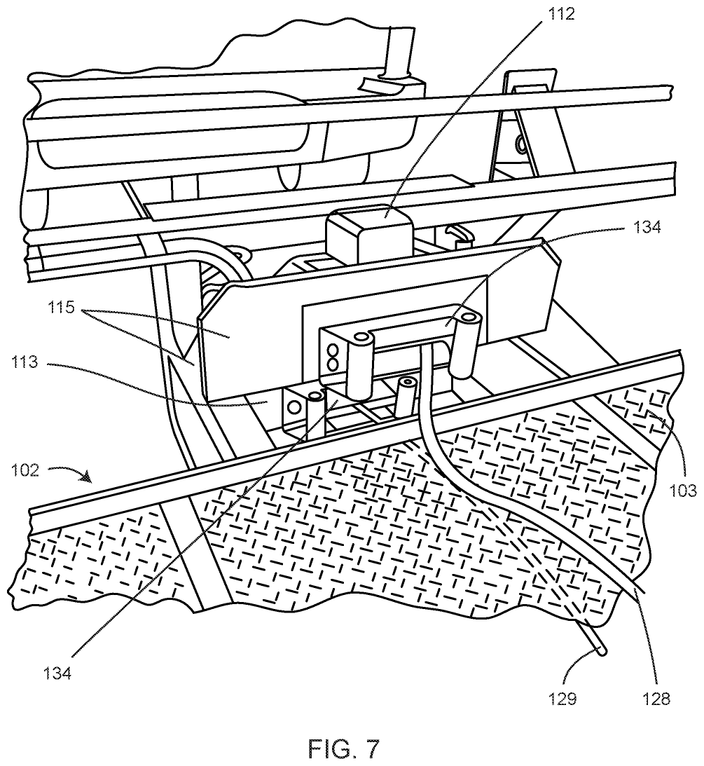

In accordance with an aspect and embodiment of the disclosure, referring specifically to FIGS. 2 and 4-6, there is provided a conveyor system frame 108 that rides on a set of rails 106 (shown in more detail in FIGS. 4 and 6) mounted on a trailer 102. A conveyor system 100 is provided which comprises: a conveyor system frame 108 having lateral cross members 120 and longitudinal cross members 122, plate wheel bays 124 where the wheels of a wrecked automobile or other load will be placed, securing rings 126 that allow securing of the load to the conveyor system frame 108, one or more winches 112 (see FIG. 7) and one or more winch ropes, or cables, 128 to transport the load with the frame on roller wheels 110 along the rails 106 to the front or rear of the trailer 102, to smoothly and securely allow the desired movement and repositioning of heavy loads on the frame 108 along the rails 106.

In accordance with another aspect and embodiment of the disclosure, there are provided points to secure the load, such as with securing rings 126 as shown, or with alternate construction or other structure. The art of securing loads for transport is well developed, and may be done by readily available commercial hooks, straps, cables, webs and other devices. These devices rely on convenient and secure attachment points. The preferred embodiment of the disclosure includes securing rings 126 on both ends of the plate wheel bays 124, but alternate embodiments may be used to create attachment points, including but not limited to cutouts in the conveyor system frame 108, lateral cross members 120 or longitudinal cross members 122.

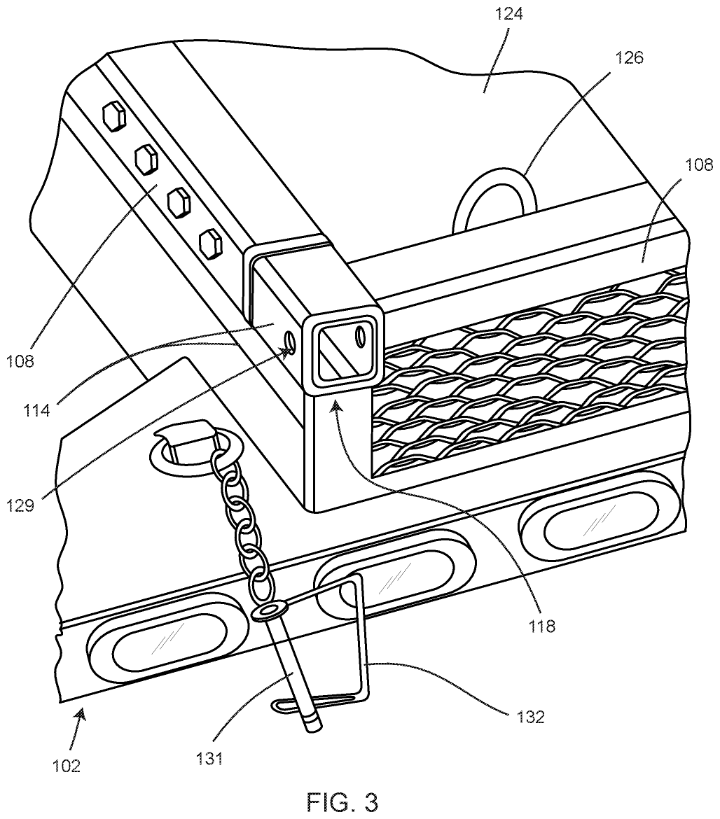

In accordance with another aspect and embodiment of the disclosure, the conveyor system frame 108 is locked in place by means of a plurality of locking hitch systems 118 further comprised of male hitch members 109 and female receptacle members 111, as shown in FIG. 4. Each rectangular female receptacle member 111 is affixed (as with welding), one such member to each corner of the lower deck of the trailer 102, and is adapted for receiving a corresponding male hitch member 109, one such male hitch member affixed (as with welding) to each corner of the conveyor system frame 108. The rectangular female receptacle members 111 located at the rear of the trailer are also designated as rear lock receivers 114. The rectangular female receptacle members 11 located at the front of the trailer are designated as forward lock receivers 116. Referring specifically to FIG. 3, when the hitch members 109 are engaged properly with the rear lock receivers 114 or forward lock receivers 116, the conveyor system frame may be locked in place by means of a locking pin 131 having a retaining loop 132 thereon for ensuring proper positioning of the locking pin in aligned holes 129 in respective male hitch members 109 and female receptacle members 111 (see FIG. 2 as an example of a conveyor system frame locked in the rear position).

As shown, for example, in FIG. 2, the conveyor system frame 108 is positioned at the rear of the trailer 102 and is locked in place using locking pins 131 with retaining loops 132. In this configuration, the conveyor system 100 is prepared to receive a wrecked automobile or other load to be loaded from the rear of the trailer 102. After the wrecked automobile is secured to the conveyor system frame 108 by means of the securing rings 126, the locking pins 131 may be disengaged so that the conveyor system frame 108 may be moved to the desired position at the front of the trailer 102 where there are awaiting engagement forward lock receivers 116 of front locking systems 118, the movement forward being accomplished preferably by means of first and second winches 112, 113 and winch cables or ropes 128, 129 and as further described in connection with FIGS. 7 and 8A and B. Once the conveyor system frame 108 is positioned at the front of the trailer 102, and the male member 109 of the conveyor lock system 118 has engaged the forward lock receiver 114, the conveyor system frame 108 may thereafter be secured by means of locking pins 131 and retaining loops 132 (see FIG. 6).

A preferred conveyor system 100 comprises an upper winch 112 and a lower winch 113. Each of the winches 112, 113 have a winch cable feed 134 through which winch ropes 128, 129, respectively spool in and out of their respective winches. The conveyor system frame 108 will be conveyed along the rails 106 installed on the trailer 102 by means of multiple winch cables 128, 129 driven by multiple winches 112, 113. Thus, preferably, one winch 112, and winch cable 128, will be used to pull the conveyor system frame 108 from the rear of the trailer 102 to the front of the trailer 102, and another winch 113 and winch cable 129 will pull the conveyor system frame 108 from the front of the trailer 102 to the rear. The conveyor system frame 108 may be conveyed along the rails 106 installed on the trailer 102 by alternate means, including without limitation by powered or manual means.

Preferably, however, the conveyor system frame 108 is conveyed along the rails 106 between the fore and aft positions by means of the double-winch (or dual-winch) system 112, 113 mentioned. The two winches 112, 113 are mounted on a framework 115 at the front or forward portion of the trailer 102 and their ropes 128, 129 are preferably attached to a winch rope/cable attachment point, such as an eyelet loop 130, welded to a forward-facing portion of the conveyor system frame 108. The winch ropes 128, 129 are routed and attached to the conveyor system frame 108 at appropriate locations (e.g., eyelet loop 130) to facilitate movement of the conveyor system frame 108 from the rear to the front of the trailer 102, or from the front to the rear of the trailer. Thus, in a preferred embodiment, the winches 112, 113 are positioned one on top of another as mounted in the framework 115 at the front end of the trailer. The rope, or cable, 129 from the bottom winch 113 extends from the winch spool past the winch's guides to a first guide pulley 133 (FIGS. 8A and 8B) mounted midway underneath the trailer 102 and then extends rearwardly to a pair of re-routing pulleys 137, 139 mounted adjacent an opening (not shown) in the trailer floor 103.

The opening in the trailer floor 103 allows passage of the lower winch rope 129 through the floor of the trailer 102, and the opening is positioned approximately three-fourths of the way back from the front of the trailer 102. One of the re-routing pulleys (re-routing pulley 137) is mounted on the trailer 102 positioned underneath the trailer adjacent the opening, and a second of the re-routing pulleys (pulley 139) is mounted adjacent the opening and on the trailer so as to be at least partially above the level of the floor 103 of the trailer to allow passage of the lower winch rope 129 guided through the pulleys through the opening and re-routed to the upper side of the trailer to extend between the trailer floor and an underside of the conveyor frame 108, the lower winch rope thus being re-routed towards the front of the trailer where an end of the lower winch rope 129 is attached to an eyelet loop 130 on the front of the conveyor frame 108. In this way, spooling in of the lower winch rope 129 serves to move the conveyor frame 108 rearwardly along its rollers 110 and rails 106 towards the rear of the trailer.

The rope or cable 128 from the upper, winch 112 extends from the upper winch spool extending along the upper surface of the floor 103 of the trailer 102 preferably to the same eye-let loop 130 on the front of the frame 108 as the lower winch rope 129 is attached to. In this way, spooling in of the upper winch rope 128 serves to pull the frame 108 along its rollers 110 and rails 106 to a forward position of the trailer 102. When the frame 108 is being pulled forward (i.e., the upper winch rope 128 is spooling in), the lower winch 113 is in an unlocked, free spinning, position so that the lower winch rope 129 is free to unspool outwardly and extend to allow the frame to be pulled fully forward. When the conveyor system frame 108 is being pulled aft (i.e., the lower winch rope 129 is spooling inwardly), the upper winch 112 is in an unlocked, free spinning, position so that the upper winch rope 128 is free to unspool outwardly and extend to allow the conveyor system frame 108 to be pulled fully rearward.

The winch system 112, 113 thus shown and described is representative of a preferred embodiment, though other means of smoothly moving the conveyor system frame 108 may be used without digressing from the spirit of the disclosure as evidenced by the claims hereof.

The roller wheels 110 are preferably attached directly to the conveyor system frame 108 in multiple sets of roller wheels 110 adjacent the plate wheel bays 124 of the frame in order to properly carry the weight of a wrecked vehicle in a stable fashion. The rails 106 are preferably comprised of ¾ inch round steel stock welded to the frame of the trailer 102. The roller wheels 110 are preferably comprised of steel roller bearing channel wheels for engaging and staying on track along the rails 106.

The plate wheel bays 124 are constructed of solid material and firmly welded or attached to the conveyor system frame 108, the lateral cross members 120, and the longitudinal cross members 122, and are of sufficient rigidity and strength to support the weight of a wrecked automobile during loading and during transport.

Alternatively, the plate wheel bays 124 may be constructed of open or porous material with sufficient rigidity and strength to support the weight of a wrecked automobile during loading and during transport. The open or porous nature of the plate wheel bays 124 may be beneficial for reducing the overall weight of the conveyor system 100, for quick shedding of water from rain or washing of the trailer 102, or from other liquids.

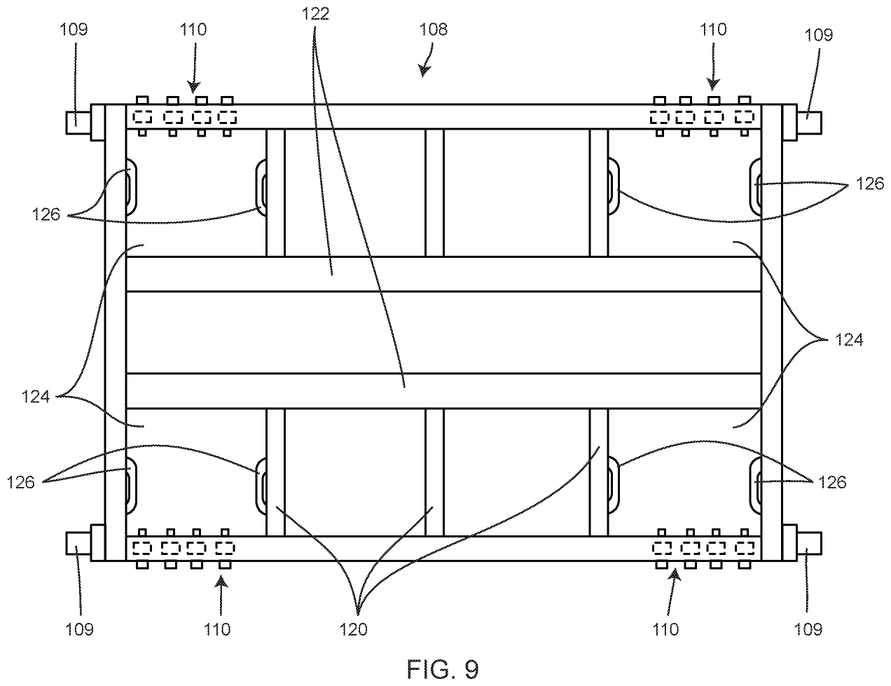

Alternatively, the longitudinal cross members 122 may be positioned within the conveyor system frame 108 and sized to correspond with the width and size of forks of a forklift (see FIG. 9). This will ensure that any sliding or rubbing of the forklift forks on the conveyor system frame 108 will be along the longitudinal cross members 122, avoiding potential damage to lateral cross members 120, plate wheel bays 124, securing rings 126 or other components of conveyor system frame 108.

In accordance with an alternate embodiment of the disclosure shown in FIG. 10, a set of lateral locking points 136 (e.g., a frame members or rack with locking pins) may be installed along the rails 106 in order to provide alternative locking positions for the conveyor system 100. This function may be used to secure the wrecked automobile in situations where the forward lock receiver 116 is not easily accessed, such as in a semi-trailer with solid sides where the width of the wrecked automobile or other load does not leave room for passage. This may also serve to allow locking of the conveyor system 100 when a portion of the wrecked automobile extends beyond the front of the conveyor system frame 108, making it impossible to fully engage the conveyor lock system 118 with the forward lock receiver 116. (See FIG. 10).

Referring specifically to FIG. 8A and FIG. 8B, it will be appreciated that the conveyance of the conveyor system frame 108 from the rear of the trailer 102 to the front accomplishes the goal of allowing full utilization of the front portion of the trailer 102 while preserving the ease of loading from the rear of the trailer 102. FIG. 8B shows the conveyor system frame 108 in the rear position, ready to load or unload the wrecked automobile. FIG. 8A shows the conveyor system 100 with its frame 108 in the forward position, ready for transport or for loading an additional wrecked automobile at the rear of the trailer 102. In FIG. 8A, some trailer side braces 104 are shown removed from the trailer 102 in order to illustrate the forward position of the conveyor system frame 100 with winch cable 128 and winch cable attach point 130.

While a preferred embodiment of the present disclosure has been shown and described, it will be apparent to those skilled in the art that many changes and modifications may be made without departing from the disclosure in its broader aspects. For example, it will be appreciated that one of ordinary skill in the art may mix and match the various components of the various embodiments of the disclosure without departing from the true spirit of the disclosure as claimed. The appended claims are therefore intended to cover all such changes and modifications as fall within the true spirit and scope of the disclosure.

What is claimed is:

1. A conveyor system adapted for installation on a lower deck of a standard automobile hauling trailer, comprising:
a plurality of rails adapted for installation on the lower deck of the standard automobile hauling trailer;
a frame adapted for transport back and forth along said rails within the trailer's exterior framework;
a plurality of roller wheels mounted on said frame and adapted for rolling carriage of said frame on said rails;
at least one winch adapted for mounting onto the trailer and adapted for pulling said frame with any cargo thereon back and forth along said rails; and
at least one lock engaged with one of said frame, said wheels, and said rails, adapted for preventing movement of said frame during loading and transport of the trailer.

2. The conveyor system of claim 1, wherein said frame comprises a rectangular framework further comprised of cross members, a plurality of plate wheel bays, and at least one welded ring adapted for receiving and tying vehicle wheels onto said frame.

3. The conveyor system of claim 2, wherein said frame further comprises longitudinally extending internal frame cross members of wider width corresponding with the width of forks on forklifts adapted for allowing scraping of front portions of the forks along said frame without catching on or damaging said frame.

4. The conveyor system of claim 1, wherein said at least one winch comprises a dual-winch system, one winch adapted for pulling said frame forward along the trailer, and another winch adapted for pulling said frame rearward along the trailer.

5. The conveyor system of claim 1, wherein said at least one lock comprises a forward hitch receiver adapted for mounting on a forward location on the trailer and adapted for receiving and retaining a corresponding forward-facing hitch mounted on said frame for locking said frame in a forward position on the trailer, and a rearward hitch receiver adapted for mounting on a rearward location on the trailer and adapted for receiving and retaining a corresponding rearward-facing hitch mounted on said frame for locking said frame in a rearward position on the trailer.

6. The conveyor system of claim 4, further comprising an automobile hauling-type trailer comprising a lowermost level bed comprising lateral side edges and at least forward external frame members, said rails being fixed adjacent each lateral side edge of said trailer, said frame having forward facing and rearward facing frame portions, further comprising a plurality of pulleys mounted on said trailer, at least one of said plurality of pulleys being fixed underneath the bed of said trailer, another one of said plurality of pulleys being mounted at least partially above the bed of said trailer, said dual-winch system being mounted on the fore frame member of said trailer, a first winch of said dual-winch system being mounted above a second winch, said first winch having a cable attached to the forward facing portion of said frame for pulling said frame forward along said trailer on said rails, said second winch having a cable adapted for being routed with said pulleys from underneath the bed to above the bed and attached to the forward facing portion of said frame, said second winch thus being adapted for pulling said frame rearward along said trailer on said rails.

7. A conveyor system on a transport trailer, comprising:
a wheeled trailer having an exterior framework, foreward and aft portions, and adapted for hauling stock on a trailer bed;
a plurality of elongated rails mounted on said trailer's bed within the exterior framework of said trailer;
a frame adapted for transporting stock within the exterior framework of said trailer;
a plurality of wheels mounted on said frame and adapted for rolling carriage of said frame on said rails;
at least one winch adapted for mounting onto the trailer and adapted for pulling said frame with any cargo thereon back and forth along said rails; and
at least one lock engaged with one of said frame, said wheels, and said rails, adapted for preventing movement of said frame during transport of the trailer.

8. The conveyor system of claim 7, wherein said frame comprises a rectangular framework further comprised of cross members, a plurality of plate wheel bays, and at least one welded ring adapted for receiving and tying vehicle wheels onto said frame.

9. The conveyor system of claim 8, wherein said frame further comprises longitudinally extending internal frame cross members of wider width corresponding with the width of forks on forklifts adapted for allowing scraping of front portions of the forks along said frame without catching on or damaging said frame.

10. The conveyor system of claim 7, wherein said at least one winch comprises a dual-winch system, one winch adapted for pulling said frame forward along said trailer, and another winch adapted for pulling said frame rearward along said trailer.

11. The conveyor system of claim 7, wherein said at least one lock comprises a forward hitch receiver mounted on a forward portion on said trailer and adapted for receiving and retaining a corresponding forward-facing hitch mounted on said frame for locking said frame in a forward position on said trailer, and a rearward hitch receiver mounted on a rearward portion on said trailer and adapted for receiving and retaining a corresponding rearward-facing hitch mounted on said frame for locking said frame in a rearward position on said trailer.

12. The conveyor system of claim 11, wherein said frame further comprises at least a forward facing frame portion, further comprising a plurality of pulleys mounted on said trailer, at least one of said plurality of pulleys being fixed underneath the bed of said trailer, another one of said plurality of pulleys being mounted at least partially above the bed of said trailer, said dual-winch system being mounted on the forward frame member of said trailer, a first winch of said dual-winch system being mounted above a second winch, said first winch having a cable attached to the forward facing portion of said frame for pulling said frame forward along said trailer on said rails, said second winch having a cable adapted for being routed with said pulleys from underneath the bed to above the bed and attached to the forward facing portion of said frame, said second winch thus being adapted for pulling said frame rearward along said trailer on said rails.
